(19) United States
(12) Patent Application Publication
(10) Pub. No.: US 2011/0233196 A1
(43) Pub. Date: Sep. 29, 2011

(54) ILLUMINATED HOT PLATE

(75) Inventors: Miguel Angel Buñuel Magdalena, Zaragoza (ES); Francisco Javier Ester Sola, Zaragoza (ES); Jose-Ramon Garcia Jimenez, Zaragoza (ES); Damaso Martin Gomez, Zaragoza (ES); José Ignacio Peña Torre, Zaragoza (ES); Daniel Sola Martinez, Zaragoza (ES)

(73) Assignee: BSH BOSCH UND SIEMENS HAUSGERÄTE GMBH, Munich (DE)

(21) Appl. No.: 13/132,644

(22) PCT Filed: Dec. 7, 2009
(86) PCT No.: PCT/EP2009/066471

§ 371 Date: Jun. 3, 2011

(30) Foreign Application Priority Data
Dec. 19, 2008 (ES) P200803706

(51) Int. Cl. H05B 6/12; H05B 6/10; F21V 33/00; B28B 1/14

(52) U.S. Cl. 219/622; 219/618; 362/92; 264/299

(57) ABSTRACT

A light-permeable hot plate includes at least one cavity filled with illuminant. The illuminant in the cavity can be excited to illuminate by an electromagnetic excitation field. The hot plate can be part of an induction hob, with the at least one cavity being arranged in a region of a cooking zone. The electromagnetic excitation field is provided to transfer energy into a household appliance which is arranged on the cooking zone.

The invention relates to a hot plate, in particular to a vitreous hot plate, for an induction hob, and to an induction hob having such a hot plate.

With conventional black glass-ceramic hot plates, optical information, e.g. user information, can be represented in only a limited way on the surface of the material utilized. Hitherto, only printed markings and metal or plastic parts have been used as differentiating elements, while user information has been derived in practice from an additional user interface, for example a display unit. In order to mark the hot plate optically, illuminated rings arranged around the cooking zones of a hot plate are known. These rings are usually in the form of light guides (optical waveguides, tubular waveguides, etc.) which are bonded to the reverse side of the glass-ceramic hot plate and are fed with light (for example by means of diodes or other light sources).

In particular induction hobs which are not illuminated by a heating element are therefore difficult to differentiate for a user.

US 2008/0099449 A1 discloses a hob in which a plasma lamp is arranged below a hot plate of an induction cooker in order to illuminate an upper face of the hot plate, which plasma lamp is excited to illuminate via electrodes and a respective power source. The plasma lamp can be excited to illuminate in that a cavity filled with xenon gas is fed by an alternating field applied between the electrodes. The plasma lamp may be configured as a concentric circle.

It is the object of the present invention to provide a possibility of optically configuring hot plates which allows flexible configuration, is simple to implement and is reliable.

This object is achieved according to the features of the independent claims. Developments of the invention are apparent from the dependent claims.

In order to achieve the object, there is specified a hot plate having at least one cavity which is filled with at least one illuminating means, in which the at least one illuminating means can be excited to illuminate by means of an electromagnetic excitation field.

Because the cavity is arranged, in particular, directly on the hot plate it is able, firstly, to be configured and positioned comparatively unhindered by other components, making possible a high degree of design flexibility. Secondly, the arrangement directly on the hot plate makes possible a clear optical marking on an upper face of the hot plate, even or especially in the case of colored or black hot plates.

A hot plate may be configured to be light-permeable, in particular transparent, or opaque. In addition, the design of the hot plate may be configured independently of the type and/or shape of the associated hob.

In principle, one cavity or a plurality of cavities may be arranged on and/or in a hot plate, or on and/or in a cooking zone of the hot plate.

A vitreous hot plate is preferred for the simplicity of introducing or adding the cavity, combined with good processability of the hot plate and therefore low manufacturing cost, and for use in many already existing types of hot plates. In particular, the base material of the hot plate may be glass, glass-ceramic, a mixture of glass and glass-ceramic or another light-permeable ceramic.

A configuration consists in that the hot plate is provided for use with an induction hob.

The induction hob may be configured, for example, for eddy current heating or for energy transfer via an alternating magnetic field to a household appliance equipped with a coil for tapping the alternating magnetic field, for example a small household appliance (toaster, coffee maker, microwave, etc.) or a cooking utensil.

The cavity may be arranged in a projecting portion of the hot plate, in which case the projection may also be provided as a separately produced element which is then connected non-releasably to the glass plate.

In particular, a cavity filled with illuminating means may be incorporated at least partially (or completely) in the hot plate. In the case of partial incorporation, the hot plate preferably forms a partial wall of the cavity.

Especially for marking and allocating circular cooking zones, a cavity filled with illuminating means may have an annular configuration, at least sectorally; that is, it may have an annular portion. However, the shape of the cavity is not restricted to an open, closed or annular basic form. Thus, the cavity may also have an oval or angular configuration. Furthermore, one or more cavities may have a spherical, teardrop-shaped or rectilinear configuration.

For precise marking of a cooking zone and for effective excitation by means of an electromagnetic excitation field, in particular an alternating magnetic field, at least one cavity filled with illuminating means is arranged in or on (in particular concentrically with) a cooking zone of the hot plate (e.g. of an induction hob).

A configuration provides that, for gentle processing of an already existing glass plate, the cavity is configured without electrodes. In that case the at least one illuminating means present in the cavity is excited by means of an external excitation field with an operating principle similar to that of a nullode. Moreover, such an embodiment has especially good longevity and reliability.

In addition, at least one electrode may be introduced into the cavity filled with an illuminating means in order to build up the electromagnetic, in particular magnetic, excitation field.

For reliable excitation of the illuminating means, it is advantageous that at least two electrodes are introduced into the cavity filled with illuminating means in order to build up the electromagnetic excitation field. This may be especially advantageous if an external electromagnetic excitation field either is not present or is too weak, for example in the case of a cavity arranged outside a cooking zone of an induction hob.

All illuminating means which can be excited to illuminate by means of an electromagnetic excitation field, either individually or in combination with one another, may be used as illuminating means. In particular, the illuminating means may comprise a noble gas or a combination of noble gases, since these are non-toxic and inert. Also usable as illuminants are: mercury or mercury compounds, halogens, carbon dioxide, and solid illuminants such as phosphorus-based illuminants, etc.

The induction hob comprises at least one induction hot plate.

There is proposed, in particular, an induction hob in which at least one cavity filled with at least one illuminating means is located in the region of a zone irradiated by the excitation field, in particular of a cooking zone, in such a manner that the at least one illuminating means can be excited to illuminate by means of the electromagnetic excitation field (including an alternating magnetic field), the electromagnetic excitation field being provided preferably for transferring energy into a household appliance, in particular a cooking utensil, arranged on the cooking zone.

Accordingly, a cavity may be arranged preferably in or on a cooking zone of an induction hob in such a manner that it is excited by means of the excitation field also generated to operate the household appliance. It may be advantageous to provide or modify a coil or a group of coils used to generate the electromagnetic excitation field in such a way that they are operated with increased power at excitation frequencies for the at least one illuminating means. In particular, the at least one coil may be operated at different frequencies and/or powers, so that the induction hob on the one hand, and the illuminating means in the cavity on the other, are excited appropriately.

In order to mark a cooking zone, a cavity may be arranged at an outer edge of the cooking zone in plan view.

The method for producing such a hot plate comprises at least the following steps: (a) evacuating the cavity, preferably by means of a vacuum pump, to a pressure range from 10⁻¹ atm to 10⁻⁵ atm, (b) filling the cavity with the at least one illuminating means, and (c) (hermetically) sealing the cavity.

The cavity may preferably have been incorporated previously in the hot plate, in particular by laser processing using a focus within the hot plate, since a joining process with join areas can be avoided in this way.

For simple processing of the hot plate, a method may also be used which includes the step of forming at least one recess in an underside of the hot plate and (in particular hermetically) covering the opening of the recess, in particular by bonding a glass plate to the open area to form the cavity.

Exemplary embodiments of the invention are described and explained below with reference to the drawings, the same reference symbols being used to designate identical elements or elements having the same function.

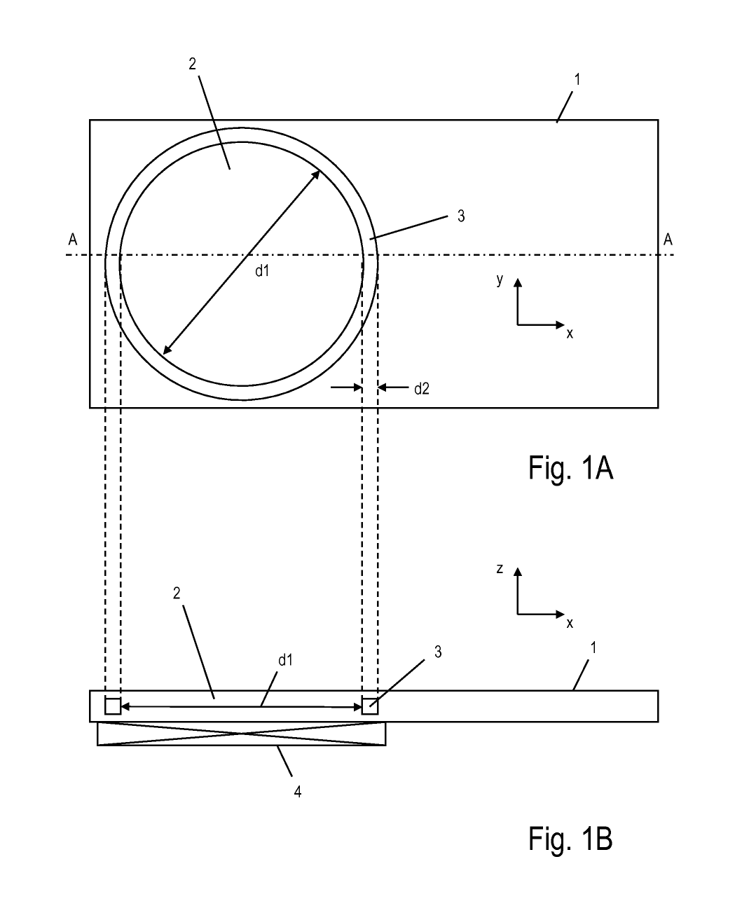

FIG. 1a shows in plan view from above a hot plate of an induction hob in which a cooking zone is delimited by an annular cavity;

FIG. 1b is a sectional representation in side view of the hot plate of FIG. 1a with an excitation source;

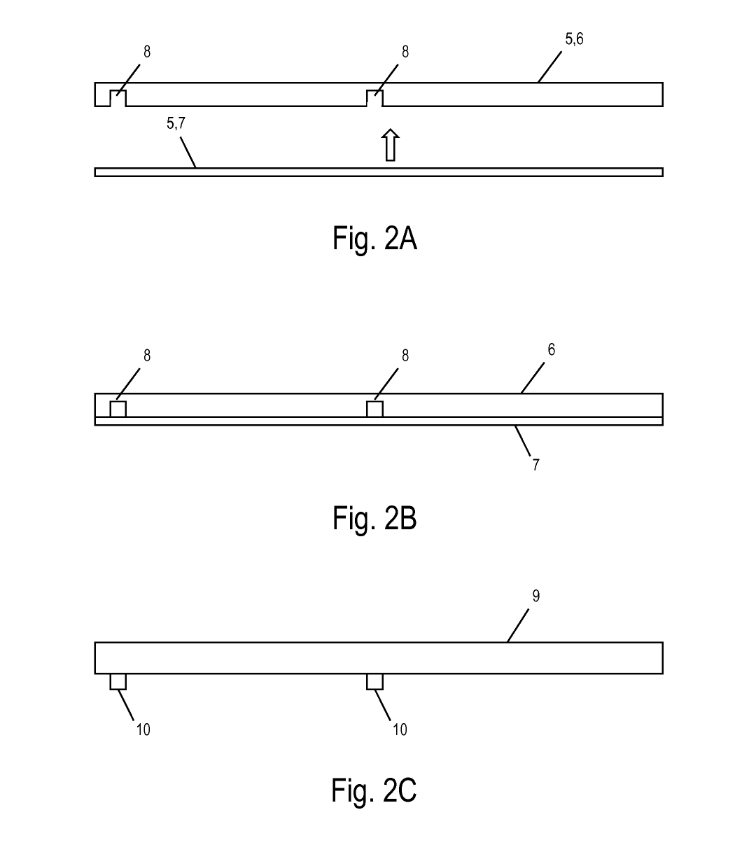

FIG. 2a is a sectional representation in side view of a hot plate produced using a different method, in a first manufacturing step;

FIG. 2b is a sectional representation in side view of the hot plate of FIG. 2a in a second manufacturing step;

FIG. 2c is a sectional representation in side view of a hot plate produced using a further method.

FIG. 1a shows in a plan view from above a hot plate 1 of an induction hob made of black glass-ceramic material, wherein a circular cooking zone 2 with a diameter d1 is delimited optically by an annular cavity 3 of thickness d2 which is filled with at least one illuminating means and is present in the hot plate 1.

FIG. 1b shows the hot plate 1 in a sectional representation along the section line A-A of FIG. 1a in a side view. The cavity 3 is completely surrounded by the material of the hot plate 1, which can be effected, for example, by laser processing of the hot plate 1. A coil (inductor coil) 4 for generating an alternating magnetic field directed upwardly (in the z direction) is located below the cooking zone 2 and the cavity 3. The alternating magnetic field passes through the cooking zone 2 and supplies a household appliance (not shown) located thereon with energy. The household appliance may be, for example, a cooking utensil capable of being operated by eddy current or a household appliance, e.g. a cooking utensil or a small household appliance, equipped with a secondary coil for tapping power from the alternating field.

The inductor coil 4 is arranged below the cavity 3, so that the cavity 3 is also fed by the alternating magnetic field or is at least partially permeated by it. The illuminating means is thereby ionized and upon recombining emits visible light which at least partially passes through the hot plate 1. In order to increase the light intensity, the cavity 3 may be provided on the underside with an optical reflector (not shown) which is permeable to the alternating magnetic field.

The illuminating means may comprise a noble gas or a mixture of noble gases. The color of the light radiated depends on the type of gas contained—for example, orange-red for neon, white-pink for helium, white for krypton, blue for argon, etc.—and also on the frequency of the field irradiated. The cavity 3 may be configured similarly to an electrodeless tubular lamp.

In the case of the hot plate 1 it is advantageous that the illuminated region (implemented by the cavity 3), for example annular in this case, does not require a separate current supply, or separate activation or wiring, and is easily visible to the user through its proximity to the upper surface of the hot plate 1, even in the case of a tinted hot plate 1. In addition to demarcating the cooking zone 2, the light emitted by the cavity 3 may give the user an impression of the power delivered by the inductor 4, since the light intensity depends on the intensity of the alternating magnetic field, and the cavity 3 therefore glows only weakly with low primary power but correspondingly brightly with high primary power.

In order to produce the hot plate 1, a glass-ceramic plate without a cavity is first processed by means of a laser processing method in which the laser is focused in the interior of the glass-ceramic plate, where it produces the cavity 3. For this purpose a through-opening (not shown) may be produced between the cavity 3 and the outside, through which the cavity 3 is evacuated, for example by generating a negative pressure in the range from 10⁻¹ to 10⁻⁵ atm using a conventional vacuum pump. An illuminating means, for example a noble gas, can then be admitted to the cavity 3 through the through-opening, in particular until only a slight negative pressure is present in the cavity 3. The through-opening can then be sealed, in particular hermetically, in particular by means of a glass adhesive, for example.

FIG. 2a is a sectional representation in a side view of a hot plate 5 produced by a different method in a first manufacturing step.

In this first manufacturing step the hot plate 5 is still divided into an upper part 6 and a thin lower cover plate 7. In the side of the upper part 6 opposite to the cover plate 7 an annular recess 8 has been formed by means of a surface removing processing method, e.g. laser ablation, sandblasting, water jet processing, micromachining, etc. In a following process step, after the recess 8 has been formed, the cover plate 7, as shown in FIG. 2a, is placed on the underside of the upper part 6 in the direction indicated by the arrow in FIG. 2b and connected firmly thereto, so that a vacuum-tight cavity is formed with the recess 8.

FIG. 2c is a sectional representation in a side view of a hot plate 9 produced by a further method in which a separately produced, annular glass tube 10 filled with illuminating means is bonded to the underside.

The exemplary embodiments shown possess, inter alia, the advantage that they make available a very efficient illumination system. In addition, a large number of different colors can be used which can even optionally be varied by means of the frequency of the irradiated excitation field. It is also possible that the colors depend on a pressure exerted on the surface of the hot plate, for example by placing a utensil thereon. The arrangement with the hot plate makes possible a simple structure. In particular, no external or separate light sources or power sources, apart from the field generated by the coil, are required.

The approach presented here is not confined to the exemplary embodiments shown. Thus, the illuminating means may also contain mercury, phosphorus or other non-gaseous substances. Furthermore, the illuminating means is not restricted to noble gases as the illuminating gases. For example, halogens, halogen mixtures or carbon dioxide may also be used.

Alternatively or additionally to the excitation of the illuminating means by irradiation of the electromagnetic field, in particular of the magnetic field, electrodes may also be introduced into the cavity. An excitation field may be generated between the electrodes. This is an alternative to the nullode-like embodiment without electrodes and is independent of a position or intensity of an external excitation source. Furthermore, blinking effects, and brightness or color transitions or the like, are possible by means of the electrodes without interrupting normal operation.

In addition, at least one cavity per cooking zone or per hob may be provided; optionally, a plurality of cavities glowing with different colors may be implemented. Furthermore, electrodeless cavities and cavities equipped with electrodes may be used jointly on or in a hot plate or a cooking zone. The approach presented here is not restricted to induction hobs.

### LIST OF REFERENCES

1 Hot plate

2 Cooking zone

3 Cavity

4 Inductor coil

5 Hob

6 Upper part of hob

7 Lower cover plate

8 Recess

9 Hot plate

10 Glass tube

d¹ Diameter of cooking zone

d² Thickness of cavity

1-15. (canceled)

16. A light-permeable hot plate, said hot plate comprising at least one cavity filled with at least one illuminant which is excitable by an electromagnetic excitation field.

17. The hot plate of claim 16, configured in the form of a vitreous hot plate.

18. The hot plate of claim 16, configured in the form of a black glass-ceramic hot plate.

19. The hot plate of claim 16 for use with an induction hob.

20. The hot plate of claim 16, wherein the at least one cavity is arranged on a cooking zone of a hob.

21. The hot plate of claim 16, wherein the at least one cavity is arranged on a cooking zone of an induction hob.

22. The hot plate of claim 16, wherein the at least one cavity is formed at least partially in the hot plate.

23. The hot plate of claim 16, wherein the at least one cavity is formed completely in the hot plate.

24. The hot plate of claim 16, wherein the at least one cavity has an annular configuration.

25. The hot plate of claim 16, wherein the at least one cavity has at least one sector of annular configuration.

26. The hot plate of claim 16, wherein the at least one cavity is configured in the absence of an electrode introduced therein.

27. The hot plate of claim 16, further comprising at least one electrode introduced into the at least one cavity.

28. The hot plate of claim 16, wherein the at least one illuminant comprises a noble gas.

29. An induction hob, comprising at least one hot plate having at least one cavity filled with at least one illuminant which is excitable by an electromagnetic excitation field.

30. The induction hob of claim 28, wherein the at least one cavity is arranged in a region of a cooking zone, with the electromagnetic excitation field exciting the at least one illuminant to illuminate, said electromagnetic excitation field being provided to transfer energy into a household appliance which is arranged on the cooking zone.

31. The induction hob of claim 29, wherein the electromagnetic excitation field transfers energy into the household appliance in the form of a cooking utensil.

32. The induction hob of claim 28, wherein the at least one cavity is disposed substantially at an outer edge of a cooking zone.

33. A method for producing a hot plate, comprising the steps of:
evacuating a cavity;
filling the cavity with at least one illuminant; and
sealing the cavity.

34. The method of claim 32, wherein the at least one cavity has been previously formed in the hot plate.

35. The method of claim 32, further comprising the steps of producing the cavity by forming a recess in an underside of the hot plate, and covering the recess.
